(19) United States
(12) Patent Application Publication
(10) Pub. No.: US 2026/0093315 A1
(43) Pub. Date: Apr. 2, 2026

(54) Hand Tracking System Using Smart Watch and Adaptive Low Frame Rate Camera

(71) Applicant: Apple Inc., Cupertino, CA (US)

(72) Inventors: Jack D. Reilly, Sunnyvale, CA (US); Behrooz Shahsavari, Los Altos Hills, CA (US); Hojjat Seyed Mousavi, San Jose, CA (US)

(21) Appl. No.: 19/315,770

(22) Filed: Sep. 1, 2025

Related U.S. Application Data
(60) Provisional application No. 63/700,342, filed on Sep. 27, 2024.

(51) Int. Cl. G06F 3/01; G02B 27/00

(52) U.S. Cl. CPC G06F 3/011; G02B 27/0093

(57) ABSTRACT

Hand tracking is performed using a head-worn device and a wearable accessory device. The head-worn device is equipped with an outward-facing camera and captures images of an environment. When the wearable accessory device is in the field of view of the camera, hand tracking can be initialized by establishing a common reference between the head-worn device and the wearable accessory device. The hand is then tracked using non-image data captured by the wearable accessory device. A neural pose network processes the non-image data to predict hand pose information. Occasionally, the camera of the head-worn device is powered on, and additional image data is captured and used to perform drift correction.

### BACKGROUND

Modern electronic devices provide new ways for users to interact with the world around them. For example, devices may be fitted with sensors which can be used to track hand motions of a user. The user may use gestures to select content, initiate activities, or the like. Typically, hand tracking is performed using image data. A camera may capture image data of a user's hand and make determinations about a position and location of the hand. Thus, the image data may be analyzed to detect user input actions.

One of the drawbacks of hand tracking methods is that the image data they rely on is provided by cameras which can consume significant power both during image capture and image processing, which can affect other system processes. Further, image-based hand tracking techniques often rely on two or more cameras to determine depth information for the hand. Thus, the power requirements of image-based hand tracking can be quite large.

What is needed is an improved technique for hand tracking that provides a low-power solution.

### BRIEF DESCRIPTION OF THE DRAWINGS

FIGS. 1A-1B show example diagrams of a user performing an input action with their hand, in accordance with one or more embodiments.

FIG. 2 shows a flow diagram of a technique for using a combination of an accessory device and a camera for hand tracking, in accordance with some embodiments.

FIG. 3 shows a flowchart of a technique for activating an accessory device as a controller, in accordance with some embodiments.

FIG. 4 shows a flowchart of a technique for monitoring drift, in accordance with some embodiments.

FIG. 5 shows a flowchart of a technique for performing drift correction, in accordance with one or more embodiments.

FIG. 6 shows a system diagram of an electronic device and wearable accessory device used for hand tracking, in accordance with one or more embodiments.

FIG. 7 shows an exemplary system for use in various hand tracking technologies.

### DETAILED DESCRIPTION

This disclosure pertains to systems, methods, and computer readable media to perform hand tracking using low-power techniques. In particular, this disclosure pertains to techniques for using a head-worn device selectively in combination with a wearable accessory device to perform hand tracking in a low power mode. Techniques include synchronizing a wearable accessory device with a camera-enabled head-worn device to determine initial pose information. From there, the hand can be tracked using the wearable accessory device without the image data from the head-worn device, until the head-worn device powers up the camera again for drift correction.

The hand tracking techniques include three phases. In a first phase, camera-based initialization is performed. For example, a head-worn device or other camera system can capture an image of an environment in front of a user. A location of the wearable accessory device (separate from the head-worn device), for example worn on a user's arm or hand, may be determined from the image data, and the image data can be combined with sensor data from the wearable accessory device to establish a common reference system between the head-worn device and the wearable accessory device. Although the description following refers to the accessory device as a “wearable accessory device,” it should be understood that in some embodiments, the wearable accessory device may be a handheld device, such as a controller, that is not worn by the user. In some embodiments, a deep-learning-based network is used to infer the basis transform, aligning the coordinates of the wearable accessory device to the coordinates of the head-worn device.

In a second phase, hand tracking is performed using non-camera sensor data from the wearable accessory device. By relying on non-camera data, the camera from the head-worn device is no longer needed for hand tracking during this phase. The tracking phase may include using on-device sensors to track a position and orientation of the hand. For example, the wearable accessory device may be equipped with an inertial motion unit (IMU), accelerometer, gyroscope, or the like. In some embodiments, the wearable accessory device uses neural odometry, applying the sensor data to a neural network to predict pose information and to reduce drift. The position and/or orientation of the hand determined from the tracking phase may be used to perform user input actions, in one or more embodiments. In some embodiments, the wearable accessory device may include additional sensors to collect data which may be used for tracking. For example, the wearable accessory device may include image sensors so that VIO/SLAM may be performed to more accurately track 3D positioning.

In a third phase, drift correction is performed. According to one or more embodiments, the wearable accessory device tracking and the head-worn device tracking may be re-synchronized. This may occur, for example, periodically, or upon a triggering condition. In some embodiments, the neural odometry network may generate a predicted confidence value for a pose. If the confidence value falls below a threshold, drift correction may be performed. Drift correction may involve employing an adaptive fusion algorithm that combines data from the sensor on the wearable accessory device with camera data, for example from the head-worn device or other system. Thus, during drift correction, the camera may be powered on to capture more image data, or otherwise used to re-initialize the tracking data.

Embodiments described herein provide an efficient manner for performing hand tracking with limited use of image data, thereby providing a less resource-intensive technique for determining position and/or orientation of a hand. Moreover, embodiments described herein provide a technical improvement to non-image hand tracking by selectively re-initializing the tracking process using camera data.

In the following disclosure, a physical environment refers to a physical world that people can sense and/or interact with without aid of electronic devices. The physical environment may include physical features such as a physical surface or a physical object. For example, the physical environment corresponds to a physical park that includes physical trees, physical buildings, and physical people. People can directly sense and/or interact with the physical environment such as through sight, touch, hearing, taste, and smell. In contrast, an XR environment refers to a wholly or partially simulated environment that people sense and/or interact with via an electronic device. For example, the XR environment may include Augmented Reality (AR) content, Mixed Reality (MR) content, Virtual Reality (VR) content, and/or the like. With an XR system, a subset of a person's physical motions, or representations are tracked, and in response, one or more characteristics of one or more virtual objects simulated in the XR environment, are adjusted in a manner that comports with at least one law of physics. As one example, the XR system may detect head movement and, in response, adjust graphical content and an acoustic field presented to the person in a manner similar to how such views and sounds would change in a physical environment. As another example, the XR system may detect movement of the electronic device presenting the XR environment (e.g., a mobile phone, a tablet, a laptop, or the like) and adjust graphical content and an acoustic field presented to the person in a manner, similar to how such views and sounds would change in a physical environment. In some situations (e.g., for accessibility reasons), the XR system may adjust characteristic(s) of graphical content in the XR environment in response to representations of physical motions (e.g., vocal commands).

There are many different types of electronic systems that enable a person to sense and/or interact with various XR environments. Examples include: head-mountable systems, projection-based systems, heads-up displays (HUD), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head-mountable system may have one or more speaker(s) and an integrated opaque display. Alternatively, a head-mountable system may be configured to accept an external opaque display (e.g., a smartphone). The head-mountable system may incorporate one or more imaging sensors to capture images or video of the physical environment, and/or one or more microphones to capture audio of the physical environment. Rather than an opaque display, a head-mountable system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In some implementations, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface.

In the following description, for purposes of explanation, numerous specific details are set forth in order to provide a thorough understanding of the disclosed concepts. As part of this description, some of this disclosure's drawings represent structures and devices in block diagram form in order to avoid obscuring the novel aspects of the disclosed concepts. In the interest of clarity, not all features of an actual implementation may be described. Further, as part of this description, some of this disclosure's drawings may be provided in the form of flowcharts. The boxes in any particular flowchart may be presented in a particular order. It should be understood, however, that the particular sequence of any given flowchart is used only to exemplify one embodiment. In other embodiments, any of the various elements depicted in the flowchart may be deleted, or the illustrated sequence of operations may be performed in a different order, or even concurrently. In addition, other embodiments may include additional steps not depicted as part of the flowchart. Moreover, the language used in this disclosure has been principally selected for readability and instructional purposes and may not have been selected to delineate or circumscribe the inventive subject matter, or resort to the claims being necessary to determine such inventive subject matter. Reference in this disclosure to “one embodiment” or to “an embodiment” means that a particular feature, structure, or characteristic described in connection with the embodiment is included in at least one embodiment of the disclosed subject matter, and multiple references to “one embodiment” or “an embodiment” should not be understood as necessarily all referring to the same embodiment.

It will be appreciated that in the development of any actual implementation (as in any software and/or hardware development project), numerous decisions must be made to achieve a developer's specific goals (e.g., compliance with system- and business-related constraints) and that these goals may vary from one implementation to another. It will also be appreciated that such development efforts might be complex and time-consuming but would nevertheless be a routine undertaking for those of ordinary skill in the design and implementation of graphics modeling systems having the benefit of this disclosure.

For purposes of this application, the term “input pose” refers to a hand pose which, when recognized by a gesture-based input system, is used for detecting input gestures.

For purposes of this application, the term “input gesture” refers to an input pose or a series of input poses which, when recognized by a gesture-based input system, is used for user input.

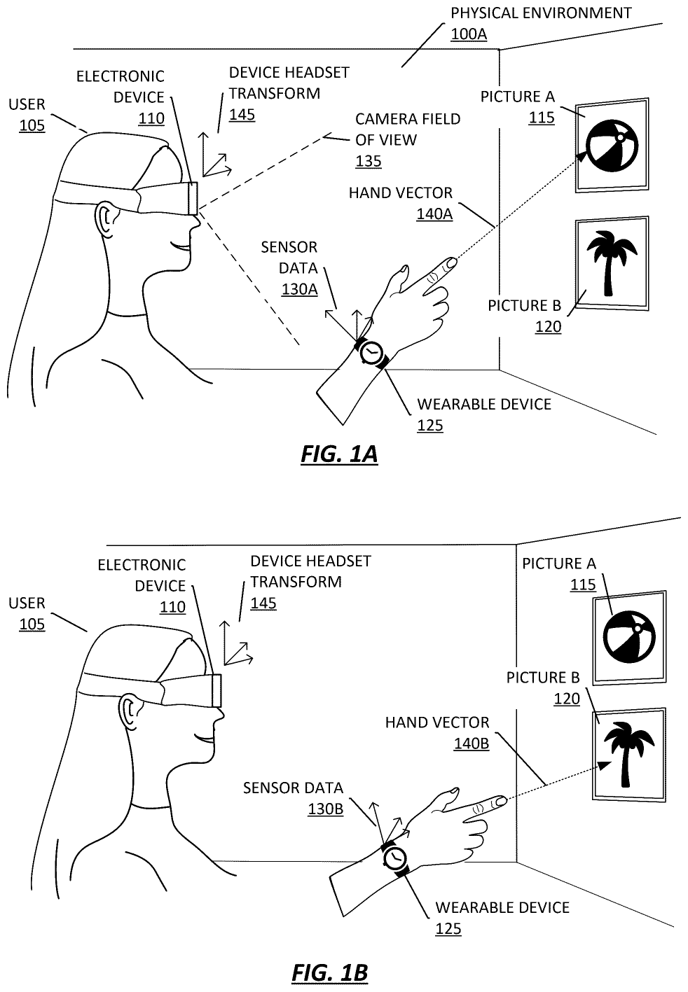

FIGS. 1A-1B show example diagrams of a user performing an input action with their hand, in accordance with one or more embodiments. In particular, FIG. 1A shows a user 105 using hand gestures to point at picture A 115 in a physical environment 100A. According to some embodiments, electronic device 110 may be a head-worn device that may include one or more outward-facing cameras having a camera field of view 135. As an example, electronic device 110 may include outward-facing sensors such as cameras, depth sensors, and the like which may capture one or more portions of the user, such as hands, arms, shoulders, and the like. Further, in some embodiments, the electronic device 110 may include inward-facing sensors, such as eye tracking cameras, which may be used in conjunction with the outward-facing sensors to determine whether a user input gesture is performed. In some embodiments, the electronic device may include a pass-through or see through display such that components of the physical environment 100A are visible. However, in some embodiments, electronic device 110 may not include a display. Electronic device 110 may also include various sensors and electronic components necessary for processing and communication.

The user may also be wearing wearable accessory device 125. According to one or more embodiments, wearable accessory device 125 may be a secondary device worn by the user, and equipped with one or more sensors from which motion and/or location data can be determined. For example, FIG. 1A shows wearable accessory device 125 as a watch worn on the user's wrist in the form of a watch. Other examples may include a ring, bracelet, or the like. The wearable accessory device may include an IMU or other motion sensor from which characteristics about the user's arm can be determined. In some embodiments, a tracking process can be initialized by combining image data captured by electronic device 110 with wearable accessory device 125 to begin a tracking process. In the example figure shown, image data captured by electronic device 110 may include a view of the wearable accessory device 125. The electronic device 110 can then register the wearable accessory device in its reference frame. This may be achieved by bridging coordinates for the electronic device with the coordinates for the wearable accessory device wearable accessory device. The result is the device headset transform 145, which represents a relationship between the two coordinate systems. Thus, when sensor data 130A is received by wearable accessory device 125, it can be tracked in a coordinate system in common with the electronic device 110.

In some embodiments, certain hand poses or motions, or sequences of poses or motions (such as snapping or double tapping) may be used to trigger user input actions. In some embodiments, wearable accessory device 125 may be configured to detect a user input motion, such as a particular pose of the hand, forearm, wrist, or the like. In the example of FIG. 1A, the user is pointing to Picture A 115. The target of the hand pose may be determined in a number of ways. In this example, the target is determined based on a hand vector 140A which extends from the user's hand to the picture A 115. Because in FIG. 1A the camera of the electronic device 110 is active, the target of the hand may be confirmed through image data.

Turning to FIG. 1B, the user 105 is shown performing an input gesture. The tracking mode now no longer relies on camera data captured from the electronic device 110. In particular, hand tracking is now performed using sensor data 130B from wearable accessory device 125, which does not include image data. Thus, tracking is performed whether or not the wearable accessory device is in the field of view of the camera, or whether or not the camera is actively capturing image data. In some embodiments, the sensor data can be applied to a neural posing model to determine a motion of the user's arm, along with a corresponding confidence level for the user motion. The motion can then be transformed based on the device headset transform 145 to determine a pose of the arm in a common coordinate system with the electronic device 110. In some embodiments, the sensor data 130B can be transmitted to the electronic device 110 such that the electronic device 110 can perform the neural tracking. Alternatively, the wearable accessory device 125 may perform the neural tracking and transmit the result to the electronic device 110. The electronic device 110 can determine corresponding hand vector 140B. Further, in some embodiments, the electronic device 110 can determine that the user is pointing to picture B 120 if a location of picture B 120 is available in a local environment map, or is otherwise known to the electronic device 110. For example, a relationship between the pose of the wearable accessory device and the hand may be known, for example from enrollment data or other user-specific data. Alternatively, a relationship between the pose of the wearable accessory device and the hand may be inferred. The vector may be determined based on a general direction the hand is pointing based on the position of the hand and/or wearable accessory device 125. Additionally, the action of performing a watch gesture can be a signal to the headset to power on camera and to determine the target of the pointing direction by inferring a depth and semantic representation of the scene from the camera post-gesture to determine an intersection point of the vector with an object or component of the environment.

As will be described in greater detail below, the techniques described herein allow for drift correction. In particular, various parameters of the tracking can be monitored to determine whether a correction is needed. This may occur, for example, periodically, in response to a determination that a confidence value of the positional information falls below a predetermined level, or the like. According to some embodiments, drift correction involves obtaining image data of the wearable accessory device, either at the time drift correction is triggered, or when the wearable accessory device is within a field of view of the camera. In some embodiments, the user may be prompted to place the wearable accessory device in the field of view of the camera. The determined position of the wearable device based on the image data can then be used to re-anchor the wearable accessory device to the common coordinate system.

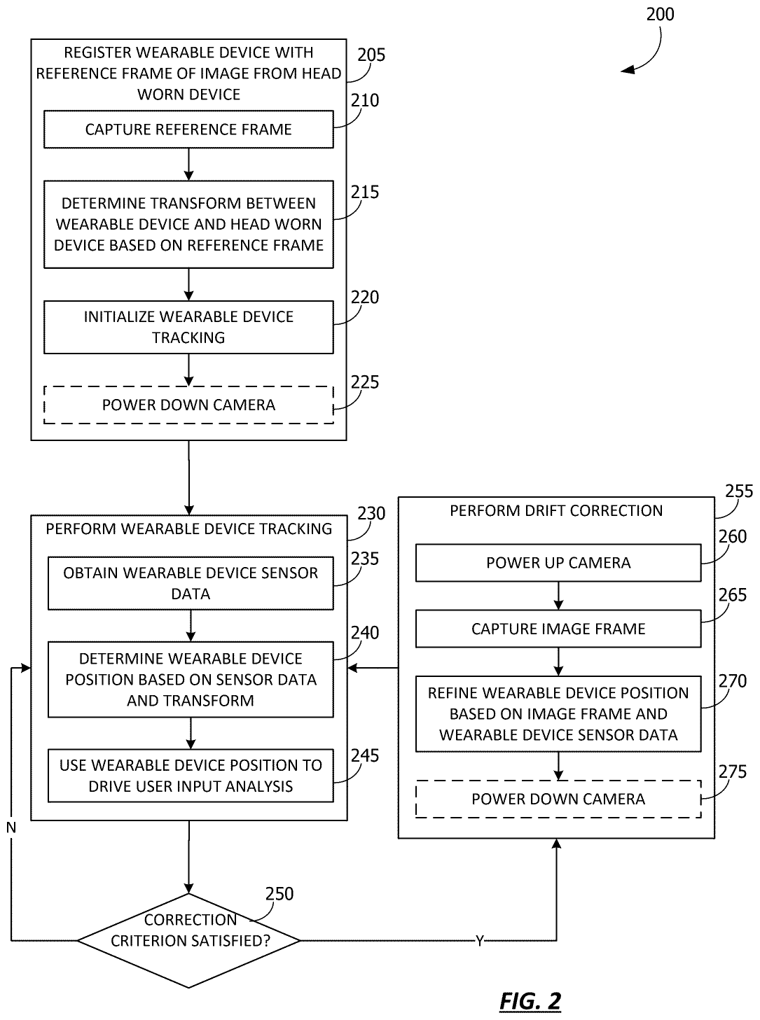

FIG. 2 shows a flow diagram of a technique for using a combination of an accessory device and a camera for hand tracking, in accordance with some embodiments. In particular, FIG. 2 is directed to a technique for selectively using camera data to support hand tracking using non-image sensor data. For purposes of explanation, the following steps will be described as being performed by particular components. However, it should be understood that the various actions may be performed by alternate components. The various actions may be performed in a different order. Further, some actions may be performed simultaneously, and some may not be required, or others may be added.

The flowchart 200 begins at block 205, where the wearable accessory device is registered with the reference frame of the camera. According to one or more embodiments, the registration process includes, at block 210, capturing a reference frame. The reference frame may be captured by a camera on the head-worn device, such as electronic device 110. As described above, the camera may be an outward facing camera directed toward an environment, that is configured to capture scene data in which a user's hand or arm is visible, or more particularly, in which a wearable accessory device 125 is visible.

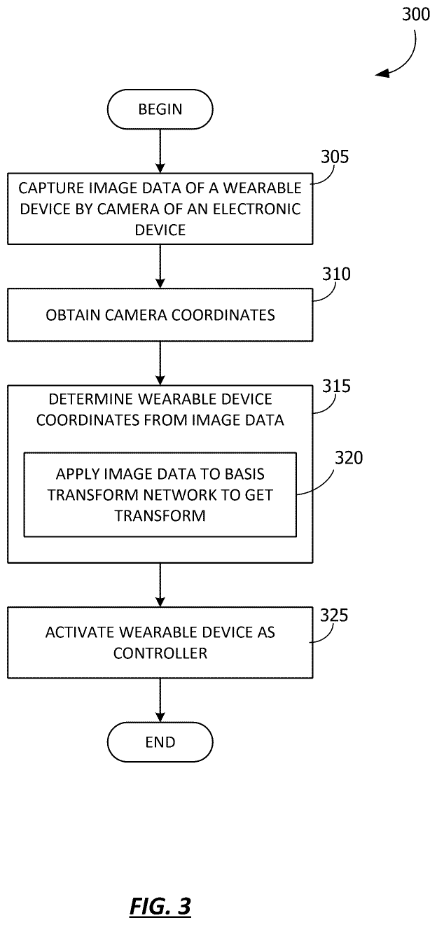

The flowchart 200 proceeds to block 215, where the transform is determined between the wearable accessory device and the head-worn device based on the reference frame. The position of the wearable accessory device visible in the reference frame is compared against the wearable accessory device sensor data to determine the transform. In some embodiments, the image data may be used as input into a network trained to predict positional information for the device based on image data. Then, at block 220, wearable accessory device tracking is initialized. Alternatively, a rule-based deterministic process can be used to map the image data to positional information for the device. In some embodiments, initializing the wearable accessory device tracking activates the wearable accessory device as a controller. For example, the wearable accessory device can be tracked to determine positional information which can then be used to determine user input parameters, such as a hand or arm pose or orientation. Optionally, as shown at decision block 225, the camera may be powered down. That is, while the wearable accessory device is activated as a controller, camera data is not used to track the wearable accessory device. However, in some embodiments, the camera may remain powered up or in a high-power mode, for example if the camera is used for other functions of the head-worn device. However, those camera frames are not used for wearable accessory device tracking. The process for registering the wearable accessory device will be described in greater detail below with respect to FIG. 3.

The flowchart 200 proceeds to block 230, where wearable accessory device tracking is performed. As described above, wearable accessory device tracking may involve determining a position and/or orientation of a hand or arm of a user based on sensor data captured by the wearable accessory device. At block 235, wearable accessory device sensor data is obtained. In some embodiments, wearable accessory device sensor data may be obtained from an IMU or other motion sensor on or in the wearable accessory device. The wearable accessory device sensor data may therefore be non-camera sensor data.

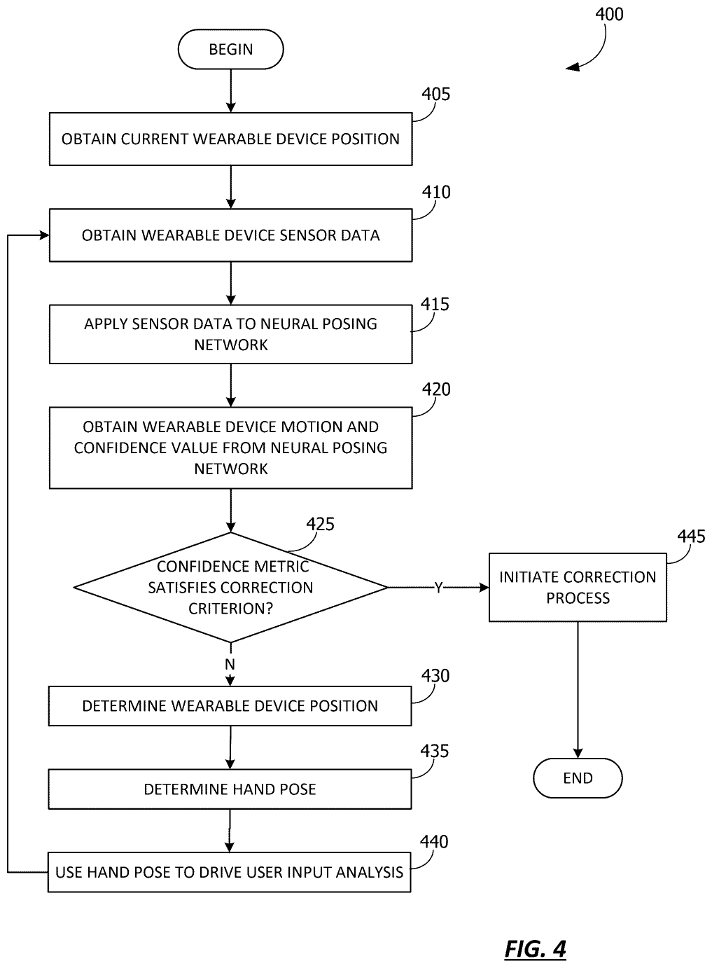

The flowchart 200 proceeds to block 240, where the wearable accessory device position is determined based on the sensor data and the transform determined during registration. In particular, an offset from a previous known position, such as a translation and/or rotation, is determined from the motion data from the wearable accessory device sensor data. In addition, the transform may be used to translate a wearable accessory device position into a common coordinate system with the head-worn device. At block 245, the wearable accessory device position is used to drive user input analysis. For example, a direction or pose of a hand or arm may be used to detect where to drive a user input action. This may include, for example, interacting with virtual content, referencing physical objects to the wearable accessory device or head-worn device, or the like. The process for performing wearable accessory device tracking will be described in greater detail below with respect to FIG. 4.

At block 250, a determination is made as to whether a correction criterion is satisfied. The correction criterion may indicate that drift correction should be performed to ensure accuracy of the wearable accessory device tracking. In some embodiments, correction criterion may be satisfied occasionally or periodically, such as after a predefined amount of time. As another example, the correction criterion may be satisfied based on confidence values for the wearable accessory device tracking. For example, a learned network or a rules-based, deterministic model that is used to determine the wearable accessory device motion at block 240 may provide the confidence value which may be used to determine whether a correction criterion is satisfied. In some embodiments, the correction criterion may include a combination of factors which may be weighted based on a particular user, device, environment, application, or the like. Alternatively, the correction criterion can include a determination about whether the wearable accessory device is visible to the camera. The head-worn device can determine visibility based on communicated location information from the wearable accessory device, or based on the wearable accessory device's known location to the head-worn device. If the determination is made that the correction criterion is not satisfied, then the flowchart returns to block 230, and wearable accessory device tracking continues to be performed without consideration of camera data.

Returning to block 250, if a determination is made that a correction criterion is satisfied, then the flowchart proceeds to block 255, and drift correction is performed. In some embodiments, performing drift correction includes, at block 260, powering up the camera of the head-worn device or other electronic device in the environment. At block 265, one or more image frames are captured.

The flowchart 200 proceeds to block 270, where the wearable accessory device position is refined based on the image data and the wearable accessory device sensor data. For example, a true position of the wearable accessory device may be determined from the captured image frame, and compared against a calculated position from wearable accessory device tracking. In doing so, the wearable accessory device can be reinitialized for wearable accessory device tracking. At optional block 275, the camera may be powered down, as image data is not used for wearable accessory device tracking. The flowchart then proceeds to block 230, where wearable accessory device tracking is performed.

FIG. 3 shows a flowchart of a technique for registering a wearable accessory device for wearable accessory device tracking. In particular, FIG. 3 describes an example technique for Determining a common coordinate system between the head-worn device and the wearable accessory device such that wearable accessory device tracking can be performed, as described above with respect to block 205 of FIG. 2. For purposes of explanation, the following steps will be described as being performed by particular components, such as those described above with respect to FIGS. 1A-1B. However, it should be understood that the various actions may be performed by alternate components. The various actions may be performed in a different order. Further, some actions may be performed simultaneously, and some may not be required, or others may be added.

The flowchart 300 begins at block 305, where image data is captured of environment where the wearable accessory device is present period in some embodiments, the imaging may be captured by a camera of an electronic device, such as a head-worn device as shown by electronic device 110 of FIG. 1A.

Flowchart 300 proceeds to block 310, where camera coordinates are obtained.

The camera coordinates indicate a position of the camera capturing the image. Additionally, or alternatively, the coordinates may correspond to the electronic device in which the camera is housed, such as the head-worn device.

At block 315, wearable accessory device coordinates are determined from the image data. The coordinates for the wearable accessory device can be determined in a number of ways. For example, as shown at block 320, the image data may be applied to a basis transform network to obtain a transform between the coordinates of the camera capturing the image and the position of the wearable accessory device. The basis transform network may be a neural network trained to predict pose information of an object based on image data. For example, a relative location of the wearable accessory device and a pose of the wearable accessory device can be predicted from the image data. In some embodiments, the basis transform network may use one or more image frames, and may use a single frame or stereo frames. That is, the depth may be predicted based on a single image frame without relying on stereo frames, depth sensor data, or other sensor data captured by the head-worn device. Accordingly, motion data collected at the wearable accessory device can then be used against the basis transform to determine an updated position of the wearable accessory device and, thus, the hand. Said another way, the basis transform bridges the coordinates of the head-worn device with the coordinates of the wearable accessory device for determination of hand-based user input actions. As another example, a formulaic approach may be used based on heuristics and characteristics of the image data to determine wearable accessory device coordinates.

The flowchart 300 concludes at block 325, where the wearable accessory device is activated as a controller. In some embodiments, activating the wearable accessory device as a controller involves modifying the operation of an image sensor of the head-worn device. For example, the camera may be disabled. As another example, the camera may enter a low power mode. Accordingly, the motion sensor data from the wearable accessory device is fused with the camera of the head-worn device.

Turning to FIG. 4, a flowchart is presented of a technique for performing hand tracking using motion data from the wearable accessory device without camera data. In particular, FIG. 4 describes an example technique for estimating hand position based on motion data captured by the wearable accessory device, as described above with respect to block 230 of FIG. 2. For purposes of explanation, the following steps will be described as being performed by particular components, such as those described above with respect to FIGS. 1A-1B. However, it should be understood that the various actions may be performed by alternate components. The various actions may be performed in a different order. Further, some actions may be performed simultaneously, and some may not be required, or others may be added.

The flowchart formula begins at block 405, where accurate position of the wearable accessory device is obtained. The current wearable accessory device position at 405 may correspond to a wearable accessory device position at the time when the wearable accessory device is activated as a controller, for example at block 325 from FIG. 3. The position may be considered accurate because it has been determined using not only the sensor data from the wearable accessory device, but camera data and/or other sensor data captured from another device from the registration process, such as the head-worn device.

The flowchart 400 proceeds to block 410, where sensor data is obtained at the wearable accessory device. As described above, sensor data may include motion data such as data captured from an IMU, accelerometer, gyroscope, magnetometer, or the like. The sensor data may therefor indicate a change in position and/or location of the wearable accessory device. For example, the sensor data may indicate translation and/or rotation characteristics of the detected motion.

At block 415, the sensor data is applied to a neural posing model. According to one or more embodiments, the neural posing model may be a deep learning-based network configured to process motion data, such as IMU data, to estimate a pose of the device. For example, the neural posing model may be configured to predict the translation and rotation based on the IMU data. Because the sensor data may lose accuracy over time, the neural posing model may provide more accurate motion data than relying directly on the sensor data. In addition, the neural posing model may provide a confidence value of the predicted motion data. Thus, at block 420, the flowchart 400 includes obtaining the wearable accessory device motion data and confidence value from the sensor data.

The flowchart 400 proceeds to block 425, where a determination is made as to whether the confidence value satisfies a correction criterion. The correction criterion may be a value of the confidence value that indicate that the accuracy of the predicted positional information. In some embodiments, the determination may also consider whether the wearable accessory device is within a field of view of the head-worn device. If the confidence value is sufficient such that the correction criterion is not satisfied, then the flowchart 400 proceeds to block 430. At block 430, a wearable accessory device position is determined. In particular, an offset from a previous known position, such as a translation and/or rotation, is determined from the motion data from the wearable accessory device sensor data. In addition, the transform may be used to translate a wearable accessory device position into a common coordinate system with the head worn device, for example by applying the offset to the previous known position such as the position obtained at block 405.

At block 435, a hand pose is determined based on the wearable accessory device pose. For example, as described in FIG. 1B, a hand vector 140B can be determined from a pose of the wearable accessory device 125 based on a predefined or inferred spatial relationship between the hand and the wearable accessory device 125. The hand vector may be specific to a user, or may be determined generally based on the position and/or orientation of the wearable accessory device.

The flowchart 400 proceeds to block 440, the hand pose is used to drive user input analysis. For example, the hand pose may be analyzed to determine whether the hand is pointing toward a registered object in the physical environment with which the user can interact upon selection. To that end, in some embodiments, the hand pose may be sufficient to trigger a user input action. As another example, the hand pose may be used in conjunction with other user input triggers, such as detected user input from voice, tactile input, visual input, eye tracking, or the like, to determine whether a user input action should be triggered. The flowchart 400 then returns to block 410, and additional sensor data is received.

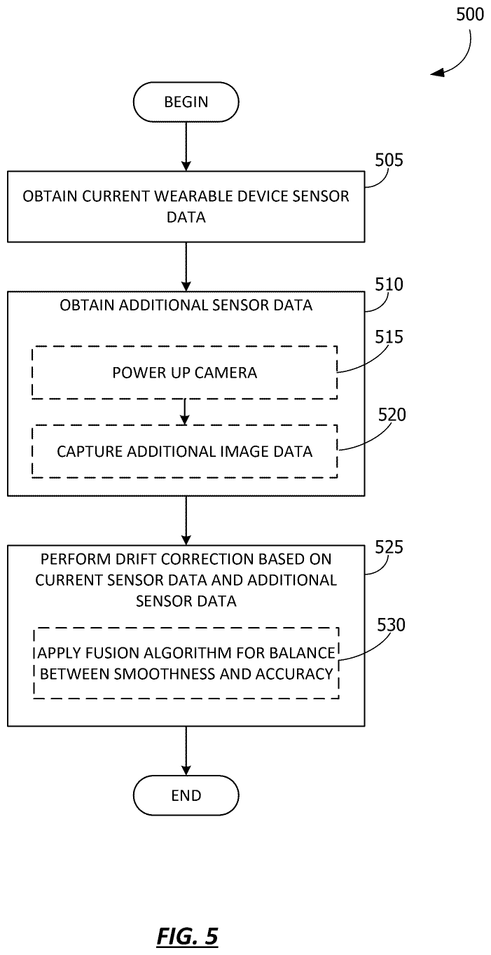

Returning to block 425, if a determination is made that the confidence value satisfies the correction criterion, such as if the parameters that define the criterion are met, then the flowchart 400 concludes at block 445, and the correction process is initiated. In particular, the correction process may correspond to a drift correction process in which the wearable accessory device and head-worn device are re-anchored, as will be described in greater detail below with respect to FIG. 5.

FIG. 5 shows a flowchart of a technique for performing drift correction, in accordance with one or more embodiments. In particular, FIG. 5 illustrates process for re-anchoring the wearable accessory device to the head-worn device to improve accuracy of the wearable accessory device tracking, as described above with respect to block 255 of FIG. 2. For purposes of explanation, the following steps will be described as being performed by particular components, such as those described above with respect to FIGS. 1A-1B. However, it should be understood that the various actions may be performed by alternate components. The various actions may be performed in a different order. Further, some actions may be performed simultaneously, and some may not be required, or others may be added.

The flowchart 500 begins at block 505, where current wearable accessory device sensor data is obtained. For example, the current wearable accessory device sensor data may correspond to the wearable accessory device sensor data which caused the confidence value to satisfy the correction criterion at block 425 of FIG. 4. Alternatively, a next frame or a later frame of wearable accessory device sensor data may be obtained concurrently with additional sensor data collected at block 510.

According to one or more embodiments, the additional sensor data collected at block 510 may be collected from an additional device, such as the head-worn device shown as electronic device 110 of FIG. 1A. In some embodiments, other forms of sensor data may additionally or alternatively be used to re-anchor the wearable accessory device to the head-worn device. This may include, for example, magnetometer data, ultrasonic data, ultra-wide band signals, or like. Obtaining additional sensor data at block 510 may include activating or powering up additional sensors, either within the wearable accessory device, or in the head-worn device, or another electronic device.

In some embodiments, the additional sensor data may be captured by a camera of the head-worn device. Thus, at block 515, the camera of the head-worn device is powered up. The step is optional because in some embodiments, the camera may already be powered, but the camera data may not be used for wearable accessory device tracking, as described above with respect to FIG. 4. In some embodiments, the camera may be transitioned from a low power mode to a high-power mode at block 515. Then at block 520, additional image data is obtained by the camera.

The flowchart proceeds to block 525, where a drift correction is performed based on the current sensor data and additional sensor data, such as the camera data. As shown in block 530, in some embodiments, a fusion algorithm may be applied. In some embodiments, the fusion algorithm may be configured to anchor the wearable accessory device to the head-worn device to strike a particular balance between smoothness and accuracy. For example, a smoother algorithm may feel more natural to a user, but may be less accurate while the correction is being performed. By contrast, a more accurate transition may feel jittery to a user, but may result in more accurate tracking. In some embodiments, additional sensor data may be used, such as the additional sensor data described above at block 510. Once the drift correction is performed, the wearable accessory device is re-anchored to the head-worn device, and wearable accessory device tracking can proceed as described above with respect to FIG. 4. Further, although not shown, the camera may then be powered down, disabled, or put into a low power mode while wearable accessory device tracking is performed.

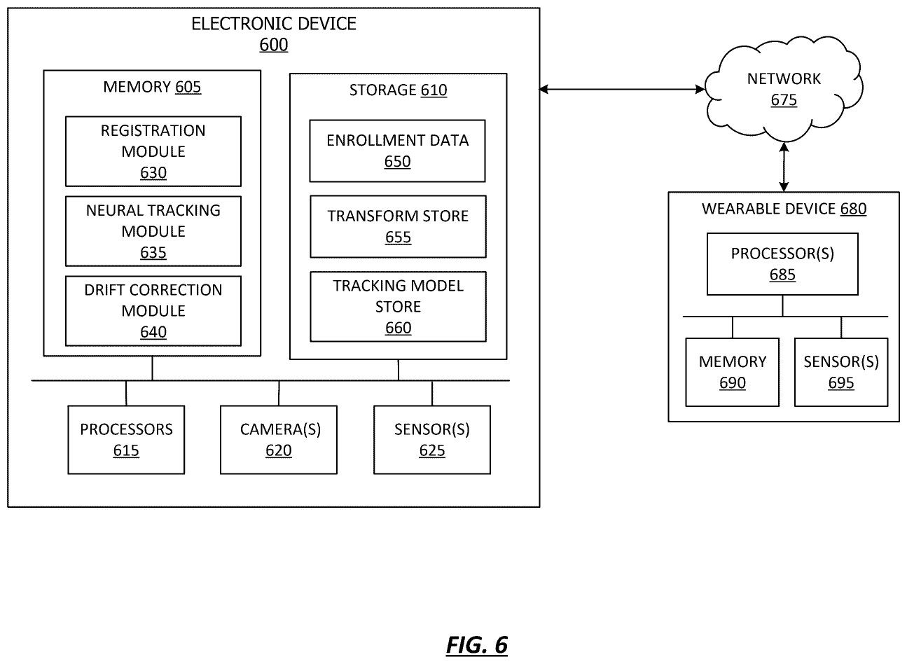

Referring to FIG. 6, a simplified block diagram of an electronic device 600 is depicted. Electronic device 600 may be part of a multifunctional device, such as a cell phone, tablet computer, personal digital assistant, portable music/video player, wearable accessory device, head-mounted systems, projection-based systems, base station, laptop computer, desktop computer, network device, or any other electronic systems such as those described herein. In some embodiments, electronic device 600 may be a head-worn device. Electronic device 600 may include one or more additional devices within which the various functionality may be contained or across which the various functionality may be distributed, such as server devices, base stations, accessory devices, etc. In addition, electronic device may be communicably couple to additional devices, such as wearable accessory device 680, across a network 675. Illustrative networks include, but are not limited to, a local network such as a universal serial bus (USB) network, an organization's local area network, and a wide area network such as the Internet. In some embodiments, the various devices may connect more directly with each other, such as over Bluetooth or other short range wireless connection.

Electronic Device 600 may include one or more processors 615, such as a central processing unit (CPU) or graphics processing unit (GPU). Electronic device 600 may also include a memory 605. Memory 605 may include one or more different types of memory, which may be used for performing device functions in conjunction with processor(s) 615. For example, memory 605 may include cache, ROM, RAM, or any kind of transitory or non-transitory computer-readable storage medium capable of storing computer-readable code. Memory 605 may store various programming modules for execution by processor(s) 615. The programming modules may include, for example, registration module 630, which is configured to register the wearable accessory device 680 with the electronic device 600, as described above with respect to FIG. 3. According to some embodiments, the registration module 630 may be configured to bridge a coordinate system of the electronic device 600 determined, for example, from one or more sensors 625, with a coordinate system of the accessory device 680. The programming modules may also include a neural tracking module 635, which is configured to determine position and/or location information from sensor data received from wearable accessory device 680, as described above with respect to FIG. 4. The neural tracking module may be configured to determine the positional information without using camera or image data. The programming modules may also include a drift correction module 640, which is configured to re-anchor the wearable accessory device 680 to the electronic device 600 when the output of the neural tracking module 635 includes a confidence value that falls below a threshold, as described above with respect to FIG. 5. The drift correction module 640 may use image data captured from cameras 620 to determine positional information for the wearable accessory device 680 from captured image data, and use the positional information to correct positional information predicted by the neural tracking module.

Electronic device 600 may also include storage 610. Storage 610 may include one more non-transitory computer-readable mediums including, for example, magnetic disks (fixed, floppy, and removable) and tape, optical media such as CD-ROMs and digital video disks (DVDs), and semiconductor memory devices such as Electrically Programmable Read-Only Memory (EPROM) and Electrically Erasable Programmable Read-Only Memory (EEPROM). Storage 610 may be utilized to store various data and structures which may be utilized for storing data related to device and/or hand tracking for user input. For example, storage 610 may include enrollment data 650, which can be used to determine a hand vector, such as a hand model, skeleton, or other information related to the user's hand which can be used in conjunction with the positional information of the wearable accessory device 680 to determine user input actions. Storage 610 may also include a transform store 655. Transform store 655 may be used to store the transform that is applied to between the positional information for the wearable accessory device 680 and the electronic device 600 such that the electronic device can determine a position and/or orientation of the wearable accessory device 680 based on sensor data collected from the accessory device. Further, storage 610 may include a tracking model store 660, which may include data for performing tracking of the wearable accessory device 680 using sensor data.

Wearable accessory device 680 may be an accessory device worn by a user. Examples of wearable accessory devices include watches, rings, bracelets, or the like which are equipped with computational structure. For example, wearable accessory device may include one or more memories 690 and one or more processors 685. Memory 690 may be configured to store computational modules which are executable by processor(s) 685. According to one or more embodiments, electronic device 600 is equipped with one or more sensor(s) 695 which can capture location and or motion data for the wearable accessory device 680. The sensor data may then be provided to the electronic device 600 for use in detecting user input actions. In some embodiments, the memory 690 and processor(s) 685 may enable the wearable accessory device 680 to perform at least some of the functionality described with respect to the computational modules of electronic device 600. For example, rather than sending IMU or other sensor data from sensor(s) 695 to the electronic device 600, the wearable accessory device may perform some processing locally. For example, the wearable accessory device 680 may run a neural velocity model, and send the velocity estimates to the electronic device 600.

Although electronic device 600 and wearable accessory device 680 are depicted as comprising the numerous components described above, in one or more embodiments, the various components may be distributed differently across the devices, or may be distributed across additional devices. Accordingly, although certain calls and transmissions are described herein with respect to the particular systems as depicted, in one or more embodiments, the various calls and transmissions may be made differently, or may be differently directed based on the differently distributed functionality. Further, additional components may be used, some combination of the functionality of any of the components may be combined.

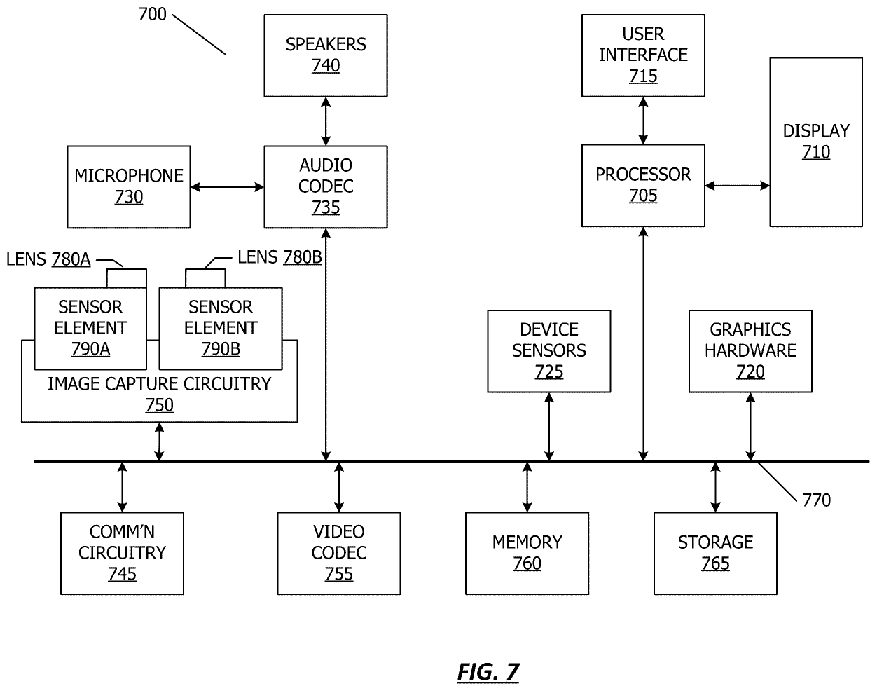

Referring now to FIG. 7, a simplified functional block diagram of illustrative multifunction electronic device 700 is shown according to one embodiment. Each of electronic devices may be a multifunctional electronic device or may have some or all of the described components of a multifunctional electronic device described herein. Multifunction electronic device 700 may include processor 705, display 710, user interface 715, graphics hardware 720, device sensors 725 (e.g., proximity sensor/ambient light sensor, accelerometer and/or gyroscope), microphone 730, audio codec(s) 735, speaker(s) 740, communications circuitry 745, digital image capture circuitry 750 (e.g., including camera system), video codec(s) 755 (e.g., in support of digital image capture unit), memory 760, storage device 765, and communications bus 770. Multifunction electronic device 700 may be, for example, a digital camera or a personal electronic device such as a personal digital assistant (PDA), personal music player, mobile telephone, or a tablet computer.

Processor 705 may execute instructions necessary to carry out or control the operation of many functions performed by device 700 (e.g., such as the generation and/or processing of images as disclosed herein). Processor 705 may, for instance, drive display 710 and receive user input from user interface 715. User interface 715 may allow a user to interact with device 700. For example, user interface 715 can take a variety of forms, such as a button, keypad, dial, click wheel, keyboard, display screen, touch screen, gaze, and/or gestures. Processor 705 may also, for example, be a system-on-chip such as those found in mobile devices and include a dedicated GPU. Processor 705 may be based on reduced instruction-set computer (RISC) or complex instruction-set computer (CISC) architectures or any other suitable architecture and may include one or more processing cores. Graphics hardware 720 may be special purpose computational hardware for processing graphics and/or assisting processor 705 to process graphics information. In one embodiment, graphics hardware 720 may include a programmable GPU.

Image capture circuitry 750 may include two (or more) lens assemblies 780A and 780B, where each lens assembly may have a separate focal length. For example, lens assembly 780A may have a short focal length relative to the focal length of lens assembly 780B. Each lens assembly may have a separate associated sensor element 790A and sensor element 790B. Alternatively, two or more lens assemblies may share a common sensor element. Image capture circuitry 750 may capture still and/or video images. Output from image capture circuitry 750 may be processed by video codec(s) 755 and/or processor 705 and/or graphics hardware 720, and/or a dedicated image processing unit or pipeline incorporated within circuitry 750. Images so captured may be stored in memory 760 and/or storage 765.

Sensor and camera circuitry 750 may capture still and video images that may be processed in accordance with this disclosure, at least in part, by video codec(s) 755 and/or processor 705 and/or graphics hardware 720, and/or a dedicated image processing unit incorporated within circuitry 750. Images captured may be stored in memory 760 and/or storage 765. Memory 760 may include one or more different types of media used by processor 705 and graphics hardware 720 to perform device functions. For example, memory 760 may include memory cache, read-only memory (ROM), and/or random-access memory (RAM). Storage 765 may store media (e.g., audio, image, and video files), computer program instructions or software, preference information, device profile information, and any other suitable data. Storage 765 may include one more non-transitory computer-readable storage mediums including, for example, magnetic disks (fixed, floppy, and removable) and tape, optical media such as CD-ROMs and DVDs, and semiconductor memory devices such as EPROM and EEPROM. Memory 760 and storage 765 may be used to tangibly retain computer program instructions, or code organized into one or more modules and written in any desired computer programming language. When executed by, for example, processor 705 such computer program code may implement one or more of the methods described herein.

Various processes defined herein consider the option of obtaining and utilizing a user's identifying information. For example, such personal information may be utilized in order to track a user's pose and/or motion. However, to the extent such personal information is collected, such information should be obtained with the user's informed consent, and the user should have knowledge of and control over the use of their personal information.

Personal information will be utilized by appropriate parties only for legitimate and reasonable purposes. Those parties utilizing such information will adhere to privacy policies and practices that are at least in accordance with appropriate laws and regulations. In addition, such policies are to be well established and in compliance with or above governmental/industry standards. Moreover, these parties will not distribute, sell, or otherwise share such information outside of any reasonable and legitimate purposes.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health-related applications, data de-identification can be used to protect a user's privacy. De-identification may be facilitated, when appropriate, by removing specific identifiers (e.g., date of birth), controlling the amount or specificity of data stored (e.g., collecting location data at city level rather than at an address level), controlling how data is stored (e.g., aggregating data across users), and/or other methods.

It is to be understood that the above description is intended to be illustrative and not restrictive. The material has been presented to enable any person skilled in the art to make and use the disclosed subject matter as claimed and is provided in the context of particular embodiments, variations of which will be readily apparent to those skilled in the art (e.g., some of the disclosed embodiments may be used in combination with each other). Accordingly, the specific arrangement of steps or actions shown in FIGS. 3-4, or the arrangement of elements shown in FIGS. 1-2, and 5-7 should not be construed as limiting the scope of the disclosed subject matter. The scope of the invention therefore should be determined with reference to the appended claims, along with the full scope of equivalents to which such claims are entitled. In the appended claims, the terms “including” and “in which” are used as the plain-English equivalents of the respective terms “comprising” and “wherein.”

1. A method comprising:
obtaining, at a head-worn device, image data of a wearable accessory device;
obtaining sensor data of the wearable accessory device;
determining a wearable accessory device transform based on the image data and the sensor data;
identifying a position of the wearable accessory device using the wearable accessory device transform and additional sensor data from the wearable accessory device;
obtaining, at the head-worn device, additional image data of the wearable accessory device; and
adjusting a tracked position of the wearable accessory device.

2. The method of claim 1, wherein the tracked position of the wearable accessory device is adjusted in response to a confidence value for the position satisfying a correction criterion.

3. The method of claim 2, further comprising:
identifying an additional position of the wearable accessory device using the additional sensor data.

4. The method of claim 3, further comprising:
re-anchoring the wearable accessory device to the head-worn device to obtain updated position information,
wherein tracking is resumed using the additional sensor data and the updated position information.

5. The method of claim 1, further comprising in response to determining that the wearable accessory device is within a field of view of a camera capturing the image data:
powering down the camera,
wherein the determination is made with the camera in operating in a powered-up mode.

6. The method of claim 1, wherein tracking the wearable accessory device comprises:
determining a hand position based on the tracking of the wearable accessory device.

7. The method of claim 6, further comprising:
detecting a user input action, and
determining user input based on the hand position and the user input action.

8. A non-transitory computer readable medium comprising computer readable code executable by one or more processors to:
obtain, at a head-worn device, image data of a wearable accessory device;
obtain sensor data of the wearable accessory device;
determine a wearable accessory device transform based on the image data and the sensor data;
identify a position of the wearable accessory device using the wearable accessory device transform and additional sensor data from the wearable accessory device;
obtain, at the head-worn device, additional image data of the wearable accessory device; and
adjust a tracked position of the wearable accessory device.

9. The non-transitory computer readable medium of claim 8, wherein the tracked position of the wearable accessory device is adjusted in response to a confidence value for the position satisfying a correction criterion.

10. The non-transitory computer readable medium of claim 9, further comprising computer readable code to:
identify an additional position of the wearable accessory device using the additional sensor data.

11. The non-transitory computer readable medium of claim 10, further comprising computer readable code to:
re-anchor the wearable accessory device to the head-worn device to obtain updated position information,
wherein tracking is resumed using the additional sensor data and the updated position information.

12. The non-transitory computer readable medium of claim 8, further comprising computer readable code to, in response to determining that the wearable accessory device is within a field of view of a camera capturing the image data:
power down the camera,
wherein the determination is made with the camera in operating in a powered-up mode.

13. The non-transitory computer readable medium of claim 8, wherein the computer readable code to track the wearable accessory device comprises compute readable code to:
determine a hand position based on the position of the wearable accessory device.

14. The non-transitory computer readable medium of claim 13, further comprising computer readable code to:
detect a user input action, and
determine user input based on the hand position and the user input action.

15. A system comprising:
one or more processors; and
one or more computer readable media comprising computer readable code executable by the one or more processors to:
obtain, at a head-worn device, image data of a wearable accessory device;
obtain sensor data of the wearable accessory device;
determine a wearable accessory device transform based on the image data and the sensor data;
identify a position of the wearable accessory device using the wearable accessory device transform and additional sensor data from the wearable accessory device;
obtain, at the head-worn device, additional image data of the wearable accessory device; and
adjust a tracked position of the wearable accessory device.

16. The system of claim 15, wherein the tracked position of the wearable accessory device is adjusted in response to a confidence value for the position satisfying a correction criterion.

17. The system of claim 16, further comprising computer readable code to:
identify an additional position of the wearable accessory device using the additional sensor data.

18. The system of claim 17, further comprising computer readable code to:
re-anchor the wearable accessory device to the head-worn device to obtain updated position information,
wherein tracking is resumed using the additional sensor data and the updated position information.

19. The system of claim 15, further comprising computer readable code to, in response to determining that the wearable accessory device is within a field of view of a camera capturing the image data:
power down the camera,
wherein the determination is made with the camera in operating in a powered-up mode.

20. The system of claim 15, wherein the computer readable code to track the wearable accessory device comprises compute readable code to:
determine a hand position based on the position of the wearable accessory device.
